(19) United States
(12) Patent Application Publication
(10) Pub. No.: US 2014/0281893 A1
(43) Pub. Date: Sep. 18, 2014

(54) METHODS AND APPARATUS TO MEASURE FEATURE USAGE ON WEBSITES

(71) Applicants: Robert Peter Borland, Palm Harbor, FL (US); David Howell Wright, Safety Harbor, FL (US)

(72) Inventors: Robert Peter Borland, Palm Harbor, FL (US); David Howell Wright, Safety Harbor, FL (US)

(21) Appl. No.: 13/838,168

(22) Filed: Mar. 15, 2013

(51) Int. Cl. G06F 17/22

(52) U.S. Cl. CPC G06F 17/2247
USPC 715/234

(57) ABSTRACT

Methods and apparatus to measure feature usage on websites are disclosed. An example method includes determining a set of rules associated with a website presented to a panelist; determining a selected rule from the set of rules, the selected rule determined by at least one of a communication received from the website, an element of a document object model of the website associated with the communication, or a uniform resource locator of the website; determining a feature of the website based on the selected rule, the communication and the element of the document object model; determining a category associated with the feature based on the selected rule, the communication and the element of the document object model; and creating an entry in an event log based on the feature and the category

### FIELD OF THE DISCLOSURE

The present disclosure relates generally to internet audience measurement and, more particularly, to methods and apparatus to measure feature usage on websites.

### BACKGROUND

Audience measurement of internet usage may be carried out by monitoring internet usage of persons (e.g., panelists) that have been selected to represent a population (e.g., using demographic groups). For example, a meter may be run on panelist computers to monitor panelist internet usage. Using one or more statistical methods, the collected internet usage data can be extrapolated to determine, for example, the size and/or demographic composition of the audience(s) for particular websites on the internet. The audience size and/or demographic information is valuable to advertisers, content providers and/or other entities interested in website usage information.

### BRIEF DESCRIPTION OF THE DRAWINGS

FIG. 1 is a block diagram of an example metering system to measure feature usage on websites.

FIG. 2 is a block diagram of an example implementation of a panelist meter of the example metering system of FIG. 1.

FIG. 3 is a block diagram of an example implementation of the data collection facility of the example metering system of FIG. 1.

FIG. 4 is a block diagram of an example implementation of the data parser of the example data collection facility of FIG. 3.

FIG. 5 is a block diagram of an example implementation of the report generator of the example data collection facility of FIG. 3.

FIG. 6 is an example webpage containing features for which usage is to be measured by the example metering system of FIG. 1.

FIG. 7 is an example event log created by the example data collection facility of FIG. 4.

FIG. 8 is a flowchart representative of example machine readable instructions that may be executed to implement the example panelist meter of FIG. 2

FIG. 9 is a flowchart representative of example machine readable instructions that may be executed to implement the example data collection facility of FIG. 3.

FIG. 10 is a flowchart representative of example machine readable instructions that may be executed to implement the example report generator of FIGS. 3 and 5.

FIG. 11 is a block diagram of an example processing system capable of executing the example machine readable instructions of FIGS. 10 and 11 and/or to implement the example panelist meter of FIG. 2 and/or the example data collection facility of FIG. 3.

### DETAILED DESCRIPTION

Advertisers, content providers and other entities are interested in measurements of activity (e.g., the type, volume, etc.) of individuals using the internet and other networks. To obtain such measurements, audience measurement entities may enlist persons to participate as panelists in measurement panels. Such panelists agree to allow the audience measurement entity to monitor their internet activity by, for example, installing a meter on, or in association with, the panelists' computers. The example meter may monitor the websites that the panelists visit by, for example, monitoring the uniform resource locator (URL) of the websites visited by the panelist, may meter how much time the panelists spend on the websites and so forth. However, simply monitoring what websites a panelist visits may not capture the full range of activity the panelist engages in on the internet.

Many modern websites allow a panelist to engage in a number of activities and use various features (e.g., chatting with other internet users, listening to music, uploading photos, viewing photos, etc.) on a website without changing the URL that the panelist is viewing. Even in instances where the URL is changed by feature usage, the changes to the URL may not sufficiently indicate the feature used. As such, monitoring the URL of a website that a panelist is viewing at a given time may not capture all of the activity and/or feature usage of the panelist.

Example methods, systems, and/or articles of manufacture disclosed herein provide for measurement of feature usage on websites. As used herein, internet feature usage is usage of elements on a website visited by a panelist (e.g., reading articles, chatting with other internet users, watching videos, posting to a discussion forum, etc.). An example method includes detecting requests made by and/or responses received by a web browser running on a panelist's computer, retrieving media from a website running on the panelist's browser and detecting the URL of the website. As used herein, media includes content, advertisements, audio, video, images, media represented by a document object model, etc. An example method also includes transmitting the detected request or response, the media and the URL. An example method also includes receiving the transmitted request or response, media and URL; parsing the received data and storing the results of the parsing in a database or other data structure. An example method further includes generating reports using the information in the database.

An example system includes a meter to run on panelists' computers to detect communications (e.g., requests and/or responses) made by or received by a web browser, to retrieve media from a website and to retrieve the URL of a website. An example system includes a data collection facility to receive this data, the data collection facility having a data parser to parse the data and a database to store the results. An example data collection facility includes a rule store containing rules instructing the data collection facility how to parse the data (e.g., by creating entries in an event log). An example data collection facility also includes a report generator to generate reports based on the information in the database (e.g., events in an event log).

An example article of manufacture includes a computer readable storage medium having instructions that, when executed, cause a computing device to detect a request made by or response received by a web browser and to retrieve media and a URL of a website. In some examples, instructions cause a computing device to receive this data, parse the data and store the results in a database. In some examples, the example instructions further cause the computing device to generate reports using the information in a database.

FIG. 1 is a block diagram of an example metering system 100 to measure feature usage on websites in accordance with the teachings of this disclosure. The example system 100 includes panelist computing devices 102, a network 110, websites 112 and a data collection facility 114.

The example panelist computing devices 102 may be implemented by personal computers, laptops, smartphones, tablets and/or other computing devices that facilitate access to the websites 112 via the network 110. The example panelist computing devices 102 are operated by panelists. The example panelists are persons selected to demographically represent a population in a study. Such persons agree to have their media usage monitored and provide their demographics as part of a panelist registration process. Alternatively, the panelists may be selected in any other manner.

Each of the example panelist computing devices 102 includes a browser 104 and a meter 106. The browser 104 is a computer software application that allows a panelist computing device 102 to connect to websites 112 via the network 110 and to view the contents of the websites 112. Alternatively, the browser 104 may be a smartphone app or any other mechanism that allows a panelist computing device 102 to view websites 112.

In the illustrated example, the meter 106 is a computer software application that monitors the internet activity of panelist computing devices 102. The example meter 106 monitors communications (e.g., commands, messages, data, requests, responses, etc.) sent to and/or from the example browser 104. An example implementation of the example meter 106 is described more fully in connection with FIG. 2.

The plurality of panelist computing devices 102 access the websites 112 through the network 110. In the illustrated example, the network 110 is the Internet. Alternatively, the network 110 may be implemented by any type(s) of public or private network(s) such as, but not limited to, a telephone network, a local area network (LAN), a cable network, a wireless network, and so forth. To enable communication via the network 110, the local panelist computing devices 102 in the illustrated example may include a communication interface that enables connection to an Ethernet, a digital subscriber line (DSL), a telephone line, a coaxial cable, any wireless connection, etc.

In the illustrated example, the websites 112 are provided by servers that serve world wide web pages via the Internet, such as news websites, music websites, social networking websites and/or any type of network connected media provider. In the illustrated example, when a panelist computing device 102 is connected to the website 112, the media provided by the website 112 is presented by the browser 104 of the panelist computing device 102.

The example data collection facility 114 of FIG. 1 receives information from the example panelist computing devices 102. In the illustrated example, the plurality of panelist computing devices 102 are connected to the data collection facility 114 via the network 110. Data from the panelist computing devices 102 is periodically and/or aperiodically (e.g., after an amount of data is collected, etc.) sent to the data collection facility 114 through the network 110. Alternatively, data from the panelist computing devices 102 can be sent to the data collection facility 114 by any other means such as mailing a disk containing the appropriate data to the data collection facility 114. The example data collection facility 114 of FIG. 1 stores and processes information from the example panelist computing devices 102 as described more fully in connection with FIG. 3.

FIG. 2 is a block diagram of an example implementation of an example media identifying meter 106 of the example internet measurement system 100 of FIG. 1. The example meter 106 includes a browser interface 200, a timestamper 201, a receiver 202, a communication analyzer 203, a URL capturer 204, a media interface 206, an I/O monitor 207, a data buffer 208 and a data transmitter 210.

The browser interface 200 of the illustrated example monitors the example browser 104 via one or more application programming interfaces (APIs) that allow the browser interface 200 to retrieve information about the browser 104 and the website(s) 112 being accessed by the browser 104. The example browser interface 200 of FIG. 2 detects URLs of the website(s) 112 accessed by the browser 104. Additionally, the example browser interface 200 detects media (e.g., images, articles, videos, advertisements) presented via the website(s) 112 accessed by the example browser 104. In the illustrated example, the browser interface 200 detects media from the website(s) 112 by accessing the document object model (DOM) of the website(s) 112. The example browser interface 200 also detects communications sent by or received by the example browser 104 (e.g., requests sent by the browser 104 to the website 112, or responses received by the browser 104 from the website 112). In some examples, the browser interface 200 detects other types of activity by the browser 104 through other APIs and/or using other means.

The example receiver 202 of the illustrated example receives communications detected by the example browser interface 200 when a communication is sent by or received by the example browser 104. Communications detected by the example browser interface 200 and received by the example receiver 202 include requests sent by the example browser 104 to a website and/or responses received by the browser 104 from a website. In the illustrated example, communications detected by the browser interface 200 and received by the receiver 202 include web page loads, hypertext transfer protocol (HTTP) commands, extensible markup language (XML) commands, JavaScript commands (including asynchronous JavaScript commands (i.e., AJAX)), commands for other scripting languages or any other type of communications sent by or received by the browser 104. The example timestamper 201 records a timestamp corresponding to the time at which a communication was received.

The communication analyzer 203 of the illustrated example analyzes communications received by the receiver 202 and determines whether a received communication is a communication that is to be saved by the meter 106 and transmitted to the data collection facility 112 (e.g., an important communication). In the illustrated example, the communication analyzer 203 determines whether a communication received by the receiver 202 relates to internet feature usage. In the illustrated example, some communications received by the receiver 202 do not relate to internet feature usage (e.g., metadata, website formatting instructions, website title, etc.) and the meter 106 ignores those communications. In some examples, all communications received by the receiver 202 are sent to the data collection facility 112 and the meter 106, in such examples, does not contain a communication analyzer 203.

The URL capturer 204 of the illustrated example captures a URL from the browser interface 200. For example, after a communication (e.g., a Javascript command) is received by the example receiver 202, the example URL capturer 204 requests the URL of the website 112 accessed by the example browser 104. In the illustrated example, when multiple websites 112 are simultaneously accessed by the browser 104, the URL capturer 204 captures the URL of the website 112 that is in focus in the browser 104. Alternatively, the URL capturer 204 may capture the URLs of all of the websites 112 accessed by the browser 104 when multiple websites 112 are simultaneously accessed by the browser 104.

The media interface 206 of the illustrated example receives media from the browser interface 200. For example, after a communication is received by the example receiver 202, the example media interface 206 detects media presented via the website 112 accessed by the example browser 104. In the illustrated example, the media interface 206 accesses elements of the DOM of the website 112 accessed by the browser 104. Alternatively, other media presented via the website 12 accessed by the browser 104 or other information about the structure of the website 112 may be accessed by the media interface 206. In the illustrated example, the media interface 206 accesses certain elements of the DOM of the website 112 based on the communication analyzed by the communication analyzer 203. For example, if the communication analyzed by the example communication analyzer 203 relates to a frame of the website 112, the media interface may access elements of the DOM related to the frame. Alternatively, the media interface 206 may access the entire DOM of the website 112.

In the illustrated example, when media from multiple websites 112 that are simultaneously accessed by the browser 104 are detected by the browser interface 200, the media interface 206 receives media from the website 112 that is in focus in the browser 104. Alternatively, the media interface 206 may receive media from all of the websites 112 detected by the browser interface 200 when multiple websites 112 are simultaneously accessed by the browser 104. In the example webpage 600 of FIG. 6, media received by the media interface 206 might include a webpage title 602, a photos frame 604, a hyperlinks frame 606, a chat frame 608 and an advertisements frame 610. In the example of FIG. 6, the media may also include the DOM for the webpage 600. As used herein, a frame may be any portion of a webpage such as, for example, an HTML frame, a delineated area, an IFrame, etc.

In some examples, the I/O monitor 207 of the illustrated example detects inputs to the panelist computing device 102. In the present disclosure, inputs are defined as keyboard strokes, mouse movement, mouse clicks, or other inputs to the panelist computing device 102 when a panelist is viewing the website 112 accessed by the browser 104. In some examples, when the media interface 206 accesses elements of the DOM of the website 112 relating to a frame presented by the browser 104, the I/O monitor 207 detects keystrokes entered and mouse clicks made within the boundaries of the frame. Alternatively, the I/O monitor 207 may monitor other inputs to the panelist computing device 102.

The data buffer 208 of the illustrated example stores communications received by the receiver 202, timestamps recorded by the timestamper 201, URLs captured by the URL capturer 204 and media received by the media interface 206. In the illustrated example, the media stored by the data buffer 208 consists of elements of the DOM of the website 112 accessed by the example browser 104. In some examples, the media stored by the data buffer 208 includes the entire DOM of the website 112 accessed by the browser 104. In some examples, the media stored by the data buffer 208 includes other types of media presented via the website 112 accessed by the browser.

The example data buffer 208 may store a communication, a recorded timestamp, a captured URL, detected media, and detected inputs as a data set. As additional communications are received by the example receiver 202, the timestamper 201 records corresponding timestamps, the example URL capturer 204 captures corresponding URLs, the example media interface 206 detects corresponding media and the example data buffer 208 stores the additional received communications, recorded timestamps, captured URLs and detected media as additional data sets. Alternatively, a data set may include a subset of the above elements and/or multiple data sets might be used to store a received communication, a recorded timestamp, a captured URL, detected media and detected inputs.

The data transmitter 210 of the illustrated example transmits data stored in the data buffer 208 to the data collection facility 114 via the network 110. In the illustrated example, the example data transmitter 210 transmits the data stored in the example data buffer 208 after a certain length of time (e.g., data is transmitted every ten minutes). Alternatively, the example data transmitter 210 may transmit the data in the example data buffer 208 at a predetermined time of the day (e.g., every day at midnight). Alternatively, the example data transmitter 210 may transmit the data in the example data buffer 208 when the amount of data in the data buffer 208 reaches a certain size (e.g., 80% of the storage capacity of the data buffer 208). The example data transmitter 210 transmits the data in the example data buffer 208 as a series of data sets, where each data set contains a communication, a timestamp, a URL and media. After the example data transmitter 210 transmits the data stored in the example data buffer 208, the data in the data buffer 208 is cleared to allow new data to be stored in the data buffer 208.

FIG. 3 is a block diagram of an example data collection facility 114 of the example internet measurement system 100 of FIG. 1 in accordance with the teachings of this disclosure. The example data collection facility 114 includes a data receiver 300, a data parser 302, a database 304 and a report generator 306.

The data receiver 300 of the illustrated example receives data from one or more panelist computing devices 102 via the example network 110. The data received by the example data receiver 300 includes one or more data sets (e.g., each data set containing a communication, a timestamp, a URL, media, and, in some examples, inputs). The example data receiver 300 sends the data it receives to the example data parser 302.

The data parser 302 of the illustrated example receives data sets from the example data receiver 300 and parses the data sets. The example data parser 302 analyzes the received data sets to detect internet feature usage by panelists. The example data parser 302 is described in further detail in connection with FIG. 4.

The database 304 of the illustrated example receives data from the data parser 302 and stores the data. The database 304 may be a file, a data store, a server, a disk, or any other data structure capable of storing the data received from the example data parser 302.

The report generator 306 of the illustrated example accesses data in the example database 304 to generate reports about the data. The reports may be provided to advertisers, content providers, and other entities to enable them to measure internet activity of interest to them. The example report generator 306 is described in further detail in connection with FIG. 5.

FIG. 4 is a block diagram of an example data parser 302 of the example data collection facility 114 of FIGS. 1 and 3 in accordance with the teachings of this disclosure. The example data parser 302 parses each data set received from the example data receiver 300 containing, for example, a communication, a timestamp, a URL and media. The example data parser 302 includes a rule store 400, a rule set selector 402, an event parser 404 and an event classifier 406.

The rule store 400 of the illustrated example includes rules describing how to parse data from various ones of the websites 112. The rule store 400 may be implemented as a database or other data structure capable of storing rules. Because the websites 112 may operate differently and use different types and formats of communications, the example rule store 400 includes rules for how to interpret the various communications received from the example data receiver 300, wherein the different rules correspond to different ones of the websites 112.

Each rule in the example rule store 400 is associated with one of the websites 112, such that a series of rules exists in the rule store 400 for each of the websites 112 to be measured by the measuring system 100. The rules in the example rule store 400 include instructions for modifying an event log, such as event log 700 illustrated in FIG. 7, based on a URL, a communication, media and/or inputs contained in a data set. Specifically, in the illustrated example, each rule in the rule store 400 contains a URL, a communication and one or more entries corresponding to elements of the DOM and associated instructions on how an event log should be modified. For example, a rule in the rule store 400 might contain an instruction to add a play-music event to an event when a data set contains a particular URL, a particular communication, and the data set contains an element of the DOM that has a particular value. In some examples, rules may be based on inputs in the data set (e.g., a rule might contain an instruction to add a start-chat event to the event log when keystrokes and mouse clicks were detected in a frame associated with a chat). In some examples, rules may be based on a URL pattern (e.g., a rule might contain an instruction to add a start-chat event to the event log when a URL pattern associated with chat is identified and a harmonization process is used to indicate when chat was being used).

In some examples, website vendors include a reference, such as for example a tag, embedded with certain communications sent by the website 112. These references are meant to be recognized by the example measurement system 100 to indicate usage of a specific internet feature. In these examples, the rule store 400 contains rules for the specific references sent by the website 112. In other words, the rules in the example rule store 400 include instructions for modifications that should be made to an event log when communications containing certain references are received. For example, a communication sent by the website 112 to start a chat session may include a reference that corresponds to a rule in the rule store 400 containing instructions to add a start-chat event to an event log.

The rule set selector 402 of the illustrated example selects a set of rules from the example rule store 400 to be used when a data set is being parsed. The example rule set selector 402 selects the rules from the rule store 400 corresponding to the URL contained in the data set being parsed. In some examples, this rule set is then stored in the rule set selector 402. When the example data parser 302 is to parse a new data set with the same URL as the previous data set parsed by the data parser 302, the same rule set is used. When the example data parser 302 is to parse a new data set with a different URL, the example rule set selector 402 selects a different rule set. In other words, data sets with the same URL are parsed using the same rule set and data sets with different URLs are parsed using different rule sets.

The event parser 404 of the illustrated example parses each data set received by the example data receiver 300 according to the rules selected by the example rule set selector 402. The example event parser 404 first selects a rule to use to parse the data set by iterating through the rule set selected by the example rule set selector 402 until a rule is found that corresponds to the URL, the communication and the media contained in the data set. In some examples, if no rule is found in the rule set corresponding to the URL, communication and media contained in the data set, then the example event parser 404 does not parse that data set. In some examples, the rule store 400 contains a default rule to use when the event parser 404 does not otherwise find a rule for a data set.

Once the example event parser 404 chooses the appropriate rule from the rule set selected by the example rule set selector 402, the event parser 404 parses the data set according to the chosen rule. In some examples, this involves creating or modifying entries in an event log such as the example event log 700 of FIG. 7. Because a plurality of panelist computing devices 102 send data to the data collection facility 114, a separate event log is created and maintained by the example event parser 404 for each panelist computing device 102. In the illustrated example, each rule contains instructions to modify an event log.

In the illustrated example, some rules contain instructions to add a new event to an event log. These rules correspond to data sets that indicate a new internet feature was started. In the illustrated example, these rules contain instructions to add a new event to an event log indicating a name of the event and the time the event was started. In some examples, rules contain instructions for additional items to be included when a new event is added to an event log. In the illustrated example, some rules contain instructions

In the illustrated example, some rules contain instructions to modify an event in an event log by adding an event end time to the event. These rules correspond to data sets that indicate an internet feature was ended. In the illustrated example, when an event is parsed using such a rule, the event parser 404 first finds the event to be modified in the event log and then adds the event end time. In the illustrated example, if a rule corresponding to a data set instructs an event to be modified and the event parser 404 cannot find the event to be modified, the data set is not parsed. In some examples, rules contain instructions for making other modifications to events in an event log.

The event classifier 406 of the illustrated example classifies events of the data sets parsed by the data parser 302 into categories. The example event classifier 406 assigns a category to each event parsed by the example data parser 302. In the illustrated example, the rules in the rule store 400 contain a classification of each event to be used by the event classifier 406 to classify the event. In some examples, the event classifier 406 chooses a category for an event by analyzing that data in a data set.

In the illustrated example, the event classifier 406 classifies events into one of three categories, namely collaborate, consume or contribute. The example event classifier classifies an event in the collaborate category when a user is using a website feature to collaborate with another user (e.g., chatting with another user or playing a game with another user). The example event classifier 406 classifies an event in the consume category when a user is using a website feature to consume media (e.g., watching a video or reading an article). The example event classifier 406 classifies an event in the contribute category when a user is using a website feature to contribute content (e.g., posting photos or writing a blog post). In some examples, events are assigned to other and/or additional categories.

FIG. 5 is a block diagram of an example report generator 306 of the example data collection facility 114 of FIGS. 1 and 3 in accordance with the teachings of this disclosure. The example report generator 306 includes a data retriever 500, a panelist report generator 502, an aggregate report generator 504 and a panelist classifier 506.

The data retriever 500 of the illustrated example retrieves data from the example database 304 when instructed by the example panelist report generator 502 or the example aggregate report generator 504. If instructed by the example panelist report generator 502, the panelist report generator 502 specifies a particular panelist computing device 102 and a particular time period for which a report is to be generated. The example data retriever 500 then retrieves events from event logs in the example database 304 corresponding to the particular panelist computing device 102 and particular time period specified by the example panelist report generator 502 and transmits this data to the panelist report generator 502. If instructed by the example aggregate report generator 504, the aggregate report generator 504 specifies multiple panelist computing devices 102 and a particular time period for which a report is to be generated. The example data retriever 500 then retrieves events from event logs in the example database 304 corresponding to all panelist computing devices 102 for the particular time period specified by the example aggregate report generator 504 and transmits this data to the aggregate report generator 504.

The panelist report generator 502 of the illustrated example generates a report for a panelist computing device 102 for a particular time period using data retrieved from the example database 304 by the example data retriever 500. One type of report that the example panelist report generator 502 generates is a timeline spanning the specified time period listing aspects of the internet feature usage of the panelist at each point during the time period. This timeline could list the various URLs visited by the panelist, names of specific features used by the panelist, the categories of features used by the panelist or any combination thereof. This type of report is generated by the example data retriever 500 accessing the events in one or more event logs associated with the specified panelist for the specified time period. After the example data retriever 500 retrieves the relevant events, the example panelist report generator 502 analyzes the events accessed by the example data retriever 500 to extract the desired information from each of the events (e.g., the name of each feature, the category of each feature, and/or other aspects to be included in the report). The example panelist report generator 502 then aggregates the extracted information into a report listing the desired information for the specified panelist and the specified time period.

Another type of report that the example panelist report generator 502 generates is a listing of the percentage of time during the specified time period that the panelist engaged in various internet activities. These internet activities could be broken down by the URLs visited by the panelist, specific features used by the panelist, categories of features used by the panelist or any combination thereof. This type of report can also be used to categorize a panelist based on the panelist's usage of each category of feature. This type of report is generated by the example data retriever 500 accessing the events in one or more event logs associated with the specified panelist for the specified time period. After the example data retriever 500 retrieves the relevant events, the example panelist report generator 502 analyzes the events accessed by the example data retriever 500 to extract the desired information from each of the events (e.g., the URLs visited, the category of each feature, and/or other aspects to be included in the report). The example panelist report generator 502 then aggregates the extracted information into a report listing the desired information for the specified panelist and the specified time period. The example panelist report generator 502 also generates reports based on a subset or multiple subsets of the specified time period (e.g., the panelist's internet usage every Monday between 2:00-3:00 P.M.).

The aggregate report generator 504 of the illustrated example generates a report based on the aggregate internet usage of multiple panelists for a particular time period using data retrieved from the example database 304 by the example data retriever 500. The example aggregate report generator 504 may generate a report based on the aggregate usage of all panelists with panelist computing devices 102 or any subset thereof (e.g., a subset of panelists according to demographic information, geographic location. One type of report generated by the example aggregate report generator 504 is a timeline listing the number of panelists who visited particular URLs, engaged in certain feature usage, engaged in certain categories of feature usage or any combination thereof at each point in time during the specified time period. This type of report is generated by the example data retriever 500 accessing the events in one or more event logs associated with the multiple desired panelists (e.g., all male panelists or all panelists between the ages of 18-21) for the specified time period. After the example data retriever 500 retrieves the relevant events, the example panelist report generator 502 analyzes the events accessed by the example data retriever 500 to extract the desired information from each of the events (e.g., the URLs visited, the category of each feature, and/or other aspects to be included in the report). The example panelist report generator 502 then aggregates the extracted information into a report listing the desired information for the specified panelists and the specified time period. The example aggregate report generator 504 also generates reports based on a subset or multiple subsets of the specified time period (e.g., the aggregate internet usage of panelists weekdays before 9:00 A.M.)

The panelist classifier 506 of the illustrated example classifies a panelist by assigning a category to the panelist based on the panelist's internet usage. For example, data retriever 500 accesses the events in one or more event logs associated with a specified panelist. The example panelist classifier 506 then analyzes the accessed events and determines the amount of time that a panelist has spent engaged in internet feature usage that has been classified into each of the categories considered by the example event classifier 406. In the illustrated example, the panelist classifier 506 determines how much time a panelist engages in internet feature usage classified as “consume,” how much time a panelist engages in internet feature usage classified as “collaborate,” and how much time a panelist engages in internet feature usage classified as “contribute.” The example panelist classifier 506 then applies a weighting factor to each of the amounts of time the panelist has spent engaged in internet feature usage of each of the possible categories. The weighting factor may be based on typical internet usage (e.g., if a typical internet user spends a majority of their time using the internet as a consumer, the consumer category may be weighted less than other categories), the relative importance of each of the categories, or any other weighting criteria. The example panelist classifier then classifies the panelist into one of the categories based on the weighted amounts of time determined. In the illustrated example, the panelist classifier 406 classifies the panelist as a consumer, a collaborator or a contributor.

FIG. 6 illustrates an example webpage 600 containing features whose usage is to be measured by the example metering system of FIG. 1. The example webpage 600 of FIG. 6 includes a webpage title 602, a photo window 604, a hyperlink window 606, a chat window 608 and an advertisement 610.

The webpage title 602 of the illustrated example includes the title of the webpage. The example webpage title 602 is media that is received by the example media interface 206 of FIG. 2.

The photo window 604 of the illustrated example contains one or more images displayed by an example browser 104. The example photo window 604 and/or the photos displayed therein may be media (e.g., part of the DOM of the webpage 600) that is received by the example media interface 206 of FIG. 2. In addition, the example receiver 202 of FIG. 2 may receive communications related to the example photo window 604 of FIG. 6.

The hyperlink window 606 of the illustrated example contains one or more hyperlinks displayed by an example browser 104. The example hyperlink window 606 and/or the hyperlinks displayed therein may be links to media (e.g., represented in part of the DOM of the webpage 600) that is received by the example media interface 206 of FIG. 2. In addition, the example receiver 202 of FIG. 2 may receive communications related to the example hyperlink window 606 of FIG. 6.

The chat window 608 of the illustrated example contains a record of a chat between User1 and User2. The example chat window 608 and/or the contents of the chat window 608 may be media (e.g., represented in part of the DOM of the webpage 600) that is received by the example media interface 206 of FIG. 2. In addition, the example receiver 202 of FIG. 2 may receive communications related to the example chat window 608 of FIG. 6.

The advertisement window 610 of the illustrated example contains one or more advertisements displayed by an example browser 104. The example advertisement window 610 and/or the advertisements displayed therein may be media (e.g., represented by part of the DOM of the webpage 600) that is received by the example media interface 206 of FIG. 2. In addition, the example receiver 202 of FIG. 2 may receive communications related to the example photo window 610 of FIG. 6.

FIG. 7 illustrates an example event log 700 that may be created and/or modified by the example event parser 404. The example event log 700 contains an event start column 702, an event name column 704, an event category column 706, an event end column 708 and rows 710-724.

The event start column 702 of the illustrated example lists the time that an event was started as detected by the event parser 404 of FIG. 4. The time recorded in the event start column 702 is a corresponding timestamp recorded by the example timestamper 201 of FIG. 2.

The event name column 704 of the illustrated example lists the name of an event detected by the event parser 404 of FIG. 4. The event name recorded in the event name column 704 is determined by the example event parser 404 according to a rule in the example rule store 400.

The event category column 706 of the illustrated example lists the category of an event detected by the event parser 404 of FIG. 4. The category recorded in the event category column 706 is determined by the example event classifier 406 of FIG. 4.

The event end column 708 of the illustrated example lists the time that an event ended as detected by the event parser 404 of FIG. 4. The time recorded in the event end column 708 is a corresponding timestamp recorded by the example timestamper 201 of FIG. 2.

Rows 710-724 of FIG. 7 represent different events recorded in the example event log 700. Row 710 represents a play-music event classified in the consume category that started at 1:00:15 and ended at 5:20:25. Row 712 represents an open-email event classified in the collaborate category that started at 1:03:21 and ended at 2:35:53. Row 714 represents a view-images event classified in the consume category that started at 1:21:18 and ended at 3:24:41. Row 716 represents a read-news event classified in the consume category that started at 2:42:51 and ended at 5:18:00. Row 718 represents an open-chat event classified in the collaborate category that started at 4:18:38 and ended at 5:16:35. Row 720 represents an open-video chat event classified in the collaborate category that started at 5:16:10 and ended at 5:32:54. Row 722 represents a play-music event classified in the consume category that started at 6:10:09 that has not yet ended. Row 724 represents an upload-images event classified in the contribute category that started at 6:13:31 that has not yet ended.

While an example manner of implementing the data collection facility 114 of FIG. 1 is illustrated in FIGS. 3-5, one or more of the elements, processes and/or devices illustrated in FIGS. 3-5 may be combined, divided, re-arranged, omitted, eliminated and/or implemented in any other way. Further, the example data receiver 300, the example data parser 302, the example database 304, the example report generator 306, the example rule store 400, the example rule set selector 402, the example event parser 404, the example event classifier 406, the example data retriever 500, the example panelist report generator 502, the example aggregate report generator 504, the example panelist classifier 506 and/or, more generally, the example data collection facility 114 of FIG. 1 may be implemented by hardware, software, firmware and/or any combination of hardware, software and/or firmware. Thus, for example, any of the example data receiver 300, the example data parser 302, the example database 304, the example report generator 306, the example rule store 400, the example rule set selector 402, the example event parser 404, the example event classifier 406, the example data retriever 500, the example panelist report generator 502, the example aggregate report generator 504, the example panelist classifier 506 and/or, more generally, the example data collection facility 114 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, data receiver 300, the example data parser 302, the example database 304, the example report generator 306, the example rule store 400, the example rule set selector 402, the example event parser 404, the example event classifier 406, the example data retriever 500, the example panelist report generator 502, the example aggregate report generator 504, the example panelist classifier 506 and/or, more generally, the example data collection facility 114 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example data collection facility 114 of FIG. 1 may include one or more elements, processes and/or devices in addition to, or instead of, those illustrated in FIG. 3-5, and/or may include more than one of any or all of the illustrated elements, processes and devices.

Flowcharts representative of example machine readable instructions for implementing the example panelist meter 106 of FIGS. 1 and 2, the example data collection facility 114 of FIGS. 1 and 3, and/or the example report generator 306 of FIGS. 3 and 5 are shown in FIGS. 8-10. In this example, the machine readable instructions comprise a program for execution by a processor such as the processor 1112 shown in the example processor platform 1100 discussed below in connection with FIG. 11. The program may be embodied in software stored on a tangible computer readable storage medium such as a CD-ROM, a floppy disk, a hard drive, a digital versatile disk (DVD), a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowcharts illustrated in FIGS. 8-10, many other methods of implementing the example panelist meter 106, the example data collection facility 114, and/or the example report generator 306 may alternatively be used. For example, the order of execution of the blocks may be changed, and/or some of the blocks described may be changed, eliminated, or combined.

As mentioned above, the example processes of FIGS. 8-10 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 8-10 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

FIG. 8 is a flowchart representative of example machine readable instructions for implementing the example panelist meter 106 of FIGS. 1 and 2. FIG. 8 begins when a communication is received by the example receiver 202 from the example browser interface 200 (block 802). If a communication is not received by the example receiver 202, block 802 repeats until a communication is received. When a communication is received by the example receiver 202 from the example browser interface 200 (block 802), the communication is analyzed by the example communication analyzer 203 to determine whether the communication is one that is to be recorded by the example measurement system 100 (e.g., by comparing the communication to a list of communications to be recorded). If the example communication analyzer 203 determines that the received communication is not to be recorded (block 806), control returns to block 802.

If the example communication analyzer 203 determines that the received communication is to be recorded (block 806), then the example timestamper 201 records a timestamp corresponding to the time that the communication was received from the example browser interface 200 (block 808). In the illustrated example, the timestamper 201 of a panelist meter 104 obtains the time to be recorded from a clock operating on an example panelist computing device 102 that is running the panelist meter 104. In some examples, the timestamper 201 may use other methods to obtain the time. The example URL capturer 204 then captures the URL of the website 112 accessed by the example browser 104 through the example browser interface 200 (block 810). The example media interface 206 then receives media from the browser 104 through browser interface 200 (block 812).

Once a communication has been received by the example receiver 202 (block 802), a time has been recorded (block 808), a URL has been captured by the example URL capturer 204 (block 810) and media has been received by the example media interface 206 (block 812), the example data buffer 208 stores the received communication, the recorded time, the captured URL and the received media (block 814). The example data buffer 208 then determines whether it is full (block 816). If the example data buffer 208 is full (block 816) or it is otherwise time to transmit the data in the data buffer 208 (e.g., an appropriate time has elapsed since the previous data transfer or it is the appropriate time of day to transfer data), then the data in the data buffer 208 is transmitted by the example data transmitter 210 to the example data collection facility 114 via the example network 110 (block 818). If the example data buffer 208 is not full (block 816) and it is not otherwise an appropriate time to transmit the data in the data buffer, control returns to block 802.

FIG. 9 is a flowchart representative of example machine readable instructions for implementing the example data collection facility 114 of FIGS. 1 and 3. FIG. 9 begins when the example data receiver 300 receives data (block 902). The data received by the example data receiver 300 includes one or more data sets, wherein each data set includes a communication, a timestamp, a URL and media (e.g., elements of the DOM). The example event parser 404 then loads the first data set from the data receiver 300 (block 904).

The example rule set selector 402 examines the URL of the loaded data set to determine if the current rule set contains rules for the URL (block 906). If the example rule set selector 402 determines that the current rule set matches the URL (block 906), then control passes to block 910. If the example rule set selector 402 determines that the current rule set does not match the URL of the data set being parsed or if no rule set has yet been loaded (block 906), then the example rule set selector 402 loads a rule set, in which the rule set contains all of the rules from the rule store 400 which correspond to the URL of the loaded data set (block 908).

Once the example rule set selector 402 has loaded a rule set corresponding to the data set being parsed (block 908) or if the rule set selector 402 determines that the correct rule set is already loaded (block 906), the example event parser 404 searches the rule set to find the appropriate rule to use to parse the data set and the event parser 404 loads the appropriate rule (block 910). In the illustrated example, the appropriate rule is the rule that contains the communication in the data set. Alternatively, a rule can be selected based on any of the information received by the data receiver 300.

Once the appropriate rule is found (block 910), the example event parser 404 uses the rule to determine whether the data set to be parsed represents a new event (block 912). If the example event parser 404 determines that the data set does represent a new event (block 912), then the event parser 404 creates a new entry in an event log such as the example event log 700 of FIG. 7 (block 914). In the illustrated example, the timestamp of the data set is recorded in event start column 702 and the event name identified by the event parser 404 according the rule is recorded in event name column 704. The example event classifier 406 then classifies the event (block 916). In the illustrated example, the rule contains an event category that the event classifier 406 uses to classify the event. Alternatively, the event classifier 406 analyzes the elements of the data set and determines a category in which to classify the event. In the illustrated example, once the example event classifier 406 determines a category, the event classifier 406 records the category in the event log in the event class column 706 of event log 700 of FIG. 7.

If the example event parser 404 determines that the data set to be parsed does not represent a new event (block 912), then the event parser 404 determines if the data set represents the end of an event (block 918). In the illustrated example, if the event parser 404 determines that the event is not the end of an event (block 918), then control passes to block 924. In some examples, the rule set contains rules for how to parse a data set that does not represent either an event starting or an event ending. In the illustrated example, if the event parser 404 determines from the rule that the data set to be parsed does represent an event ending (block 918), then the event parser 404 finds the corresponding entry in the event log that was created when the event was started (block 920). In the illustrated example, once the appropriate event is found, the example event parser 404 records the timestamp in the received data set into event end column 708 (block 922). Control then passes to block 924.

Control can arrive at block 924 either from block 916 after a new event was created, from block 922 after an event was ended or from block 918 when a data set represented neither a new or ending event. Once control arrives at block 924, the example event parser 404 determines whether there are additional data sets received from the data receiver 300 that have yet to be parsed. If there are additional data sets to be parsed by the example data parser 302 then control passes to block 904 and the next data set is loaded and parsed. If there are no additional data sets to be parsed by the example data parser 302, then the example of FIG. 9 ends.

FIG. 10 is a flowchart representative of example machine readable instructions for implementing the example report generator 306 of FIGS. 3 and 5. FIG. 10 begins when the example data retriever 500 retrieves an event log from the example database 304 (block 1002). The event log retrieved by the example data retriever 500 includes events to be included in the report to be generated (e.g., events from one or more panelists for a specified time period). An event in the retrieved event log to be included in the report (e.g., an event for a panelist at particular time) is extracted by the panelist report generator 502, the aggregate report generator 504 and/or the panelist classifier 506, depending on the type of report to be generated (block 1004). The example panelist report generator 502 extracts the event if a report is to be generated relating to the internet feature usage of an individual panelist. The example aggregate report generator 504 extracts the event if a report is to be generated relating to the internet feature usage of multiple panelists. The example panelist classifier 506 extracts the event if a report is to be generated classifying a panelist. The information from the event to be included in the report (e.g., the category of the event) is then extracted by the panelist report generator 502, the aggregate report generator 504 or the panelist classifier 506.

The example report generator 306 then determines whether additional events are needed from the retrieved event log (e.g., whether additional events covering different times in the time to be covered in the report need to be analyzed) (block 1008). If the example report generator 306 determines that additional events are needed (block 1008), then control returns to block 1004 and another event is extracted from the event log. If the example report generator 306 determines that additional events are not needed (block 1008), then control passes to block 1010. In block 1010, the example report generator 306 determines whether additional event logs needed to be loaded (e.g., event logs covering other panelists to be included in the report). If the example report generator 306 determines that additional event logs are needed (block 1010), then control returns to block 1002 and another event log is loaded. If the example report generator 306 determines that additional event logs are not needed (block 1010), then control passes to block 1012.

In block 1012, the event information extracted from each of the events to be included in the report is aggregated by the example panelist report generator 502, the example aggregate report generator 504 and/or the example panelist classifier 506 (e.g., determining the total amount of time during the specified time period that a specified panelist engaged in feature usage that was classified in the consume category). A report is then generated by the panelist report generator 502, the example aggregate report generator 504 and/or the example panelist classifier 506 based on the aggregated event information (block 1014). The example report generator 306 then determines whether additional reports are to be generated (block 1016). If additional reports are to be generated then control returns to block 1002. If additional reports are not to be generated then the example of FIG. 10 ends.

FIG. 11 is a block diagram of an example processor platform 1100 capable of executing the instructions of FIGS. 8-10 to implement the apparatus of FIGS. 1-5. The processor platform 1100 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors or controllers from any desired family or manufacturer.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), and/or a PCI express interface.

In the illustrated example, one or more input devices 1122 are connected to the interface circuit 1120. The input device(s) 1122 permit(s) a user to enter data and communications into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1120 of the illustrated example, thus, typically includes a graphics driver card, a graphics driver chip or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, RAID systems, and digital versatile disk (DVD) drives.

The coded instructions 1132 of FIGS. 8-10 may be stored in the mass storage device 1128, in the volatile memory 1114, in the non-volatile memory 1116, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
determining a set of rules associated with a website presented to a panelist;
determining a selected rule from the set of rules, the selected rule determined by at least one of a communication received from the website, an element of a document object model of the website associated with the communication, or a uniform resource locator of the website;
determining a feature of the website based on the selected rule, the communication and the element of the document object model;
determining a category associated with the feature based on the selected rule, the communication and the element of the document object model; and
creating an entry in an event log based on the feature and the category.

2. A method as defined in claim 1, wherein the element of the document object model relates to a frame of the website.

3. A method as defined in claim 2, wherein the feature is determined based on the selected rule, the communication, the element of the document object model, and keyboard strokes associated with the frame.

4. A method as defined in claim 2, wherein the feature is determined based on the selected rule, the communication, the element of the document object mode, and mouse clicks associated with the frame.

5. A method as defined in claim 1, wherein, when the communication includes a reference, the selected rule is determined by the reference.

6. A method as defined in claim 1, wherein the category is at least one of consume, collaborate, or contribute.

7. A method as defined in claim 1, wherein the communication is at least one of a JavaScript command, an asynchronous JavaScript command, a hypertext transfer protocol command, or a response to a request sent to the website.

8. A method as defined in claim 1, further comprising receiving a time corresponding to when the communication was received and recording the time in the event log.

9. A method as defined in claim 1, further comprising:
determining the selected rule from the set of rules based on the communication, wherein the selected rule indicates a first element of the document object model of the website associated with the communication;
determining the feature of the website based on the selected rule and the first element of the document object model; and
determining the category associated with the feature based on the selected rule and the element of the document object model.

10. A tangible machine readable storage medium comprising instructions that, when executed, cause a machine to at least:
determine a set of rules associated with a website presented to a panelist;
determine a selected rule from the set of rules, the selected rule determined by at least one of a communication received from the website, an element of a document object model of the website associated with the communication, or a uniform resource locator of the website;
determine a feature of the website based on the selected rule, the communication and the element of the document object model;
determine a category associated with the feature based on the selected rule, the communication and the element of the document object model; and
create an entry in an event log based on the feature and the category.

11. A machine readable storage medium as defined in claim 10, wherein the element of the document object model relates to a frame of the website.

12. A machine readable storage medium as defined in claim 11, wherein the feature is determined based on the selected rule, the communication, the element of the document object model, and keyboard strokes associated with the frame.

13. A machine readable storage medium as defined in claim 11, wherein the feature is determined based on the selected rule, the communication, the element of the document object mode, and mouse clicks associated with the frame.

14. A machine readable storage medium as defined in claim 10, wherein, when the communication includes a reference, the selected rule is determined by the reference.

15. A machine readable storage medium as defined in claim 10, wherein the category is at least one of consume, collaborate, or contribute.

16. A machine readable storage medium as defined in claim 10, wherein the communication is at least one of a JavaScript command, an asynchronous JavaScript command, a hypertext transfer protocol command, or a response to a request sent to the website.

17. A machine readable storage medium as defined in claim 10, wherein the instructions cause the machine to receive a time corresponding to when the communication was received and record the time in the event log.

18. A machine readable storage medium as defined in claim 10, wherein the instructions cause the machine to:
determine the selected rule from the set of rules based on the communication, wherein the selected rule indicates a first element of the document object model of the website associated with the communication;
determine the feature of the website based on the selected rule and the first element of the document object model; and
determine the category associated with the feature based on the selected rule and the element of the document object model.

19. An apparatus comprising:
a rule store containing rules associated with websites;
a rule set selector to select a set of rules from the rule store associated with a website presented to a panelist;
an event parser to determine a selected rule from the set of rules, the selected rule determined by at least one of a communication received from the website, an element of a document object model of the website associated with the communication, or a uniform resource locator of the website, and the event parser to determine a feature of the website based on the selected rule, the communication and the element of the document object model; and
an event classifier to determine a category associated with the feature based on the selected rule, the communication and the element of the document object model, the event parser to create an entry in an event log based on the feature and the category.

20. An apparatus as defined in claim 19, wherein the element of the document object model relates to a frame of the website.

21. An apparatus as defined in claim 20, wherein the feature is determined based on the selected rule, the communication, the element of the document object model, and keyboard strokes associated with the frame.

22. An apparatus as defined in claim 20, wherein the feature is determined based on the selected rule, the communication, the element of the document object mode, and mouse clicks associated with the frame.

23. An apparatus as defined in claim 19, wherein, when the communication includes a reference, the selected rule is determined by the reference.

24. An apparatus as defined in claim 19, wherein the category is at least one of consume, collaborate, or contribute.

25. An apparatus as defined in claim 19, wherein the communication is at least one of a JavaScript command, an asynchronous JavaScript command, a hypertext transfer protocol command, or a response to a request sent to the website.

26. An apparatus as defined in claim 19, wherein the event parser is to receive a time corresponding to when the communication was received and to record the time in the event log.

27. An apparatus as defined in claim 19, wherein the event parser is to select the selected rule from the set of rules based on the communication, the selected rule indicates a first element of the document object model of the website associated with the communication, the event parser is to determine the feature of the website based on the selected rule and the first element of the document object model, the event classifier is to determine the category associated with the feature based on the selected rule and the element of the document object model.
